(19) United States
(12) Patent Application Publication
(10) Pub. No.: US 2005/0192784 A1
(43) Pub. Date: Sep. 1, 2005

(54) Method for analysis of cell structure, and cell structure

(75) Inventors: Motomichi Itou, Nagoya-city (JP); Yukio Miyairi, Nagoya-city (JP)

Correspondence Address: OLIFF & BERRIDGE, PLC, P.O. BOX 19928, ALEXANDRIA, VA, 22320, US

(73) Assignee: NGK Insulators, Ltd., Nagoya-city (JP)

(21) Appl. No.: 11/066,242

(22) Filed: Feb. 25, 2005

Related U.S. Application Data
(60) Provisional application No. 60/548,860, filed on Mar. 2, 2004.

(30) Foreign Application Priority Data
Feb. 26, 2004 (JP) 2004-51844

(51) Int. Cl. B32B 3/12

(52) U.S. Cl. 703/7; 502/439; 422/180; 428/116

(57) ABSTRACT

A method for analysis of a cell structure includes an analysis step which includes replacing the cell structure or a part of the cell structure with an anisotropic solid body having property values of equivalent rigidity characteristics, creating a finite element model of the anisotropic solid body based on the property values, applying an internal temperature distribution or an external pressure to the finite element model of the anisotropic solid body, and calculating the stress to obtain a stress distribution in the anisotropic solid body. The structural analysis method is a means for analyzing the stress distribution in the cell structure due to the internal temperature distribution or external pressure which can be realized by using general-purpose computer software and hardware without performing a simulation test and making a large investment.

### BACKGROUND OF THE INVENTION AND RELATED ART

The present invention relates to a method for analysis of a cell structure using a finite element method which is capable of efficiently and quickly determining the stress distribution which occurs inside the cell structure when a partial or nonuniform temperature change occurs inside the cell structure or when an external pressure is applied to the outer circumference (body face and end face) of the cell structure, and to a cell structure which has been subjected to stress analysis using the structural analysis method.

A honeycomb structure as an example of the cell structure has been used as a catalyst substrate for an exhaust gas purification device used for a heat engine such as an internal combustion engine or combustion equipment such as a boiler, a liquid fuel or gaseous fuel reformer, or the like. The honeycomb structure is also used as a filter for trapping and removing particulate matter contained in dust-containing fluid such as exhaust gas discharged from a diesel engine.

In the honeycomb structure used for such purposes, a nonuniform temperature distribution tends to occur inside the honeycomb structure due to a rapid temperature change or local heating of exhaust gas or the like, and pressure tends to be applied to the outer wall during canning. The stress which occurs inside the honeycomb structure due to the nonuniform temperature distribution or the external pressure may cause cracks to occur. In particular, when the honeycomb structure is used as a filter (diesel particulate filter: DPF) for trapping particulate matter contained in exhaust gas from a diesel engine, since the honeycomb filter is regenerated by burning and removing the deposited carbon particulate matter, a local increase in the temperature inevitably occurs. This increases the stress which occurs inside the honeycomb structure or on the outer wall (body face) or the end face, whereby cracks easily occur.

In general, it is desirable that the honeycomb structure used for the above-mentioned purposes have a wall thickness as small as possible. This is because the specific surface area can be increased when the honeycomb structure is used as a catalyst substrate and the air-flow resistance of exhaust gas or the like can be reduced when the honeycomb structure is used as a filter. However, since the structural strength is reduced as the wall thickness becomes smaller, judgment may be required as to whether or not the structural strength of the honeycomb structure having a predetermined wall thickness can withstand the stress which may occur under the use conditions.

Conventionally, whether or not the honeycomb structure can withstand a predetermined stress has been confirmed by performing a use state simulation test using a method of increasing the temperature of the honeycomb structure in an electric kiln and thereafter immediately placing the resultant under normal temperature condition, a method of causing exhaust gas generated by burning diesel fuel using a burner to pass through the honeycomb structure and rapidly changing the temperature of the exhaust gas, a method of applying a hydrostatic pressure based on an isostatic strength test (Japanese Automobile Standards Organization (JASO) standard M505-87 published by Automotive Engineers of Japan, Inc.), or the like.

However, the above test method takes time, and poses limitations on possible test conditions. It is known that the stress which occurs in the honeycomb structure due to the internal temperature distribution or the external pressure may change depending on not only the wall thickness, but also the cell size, the property values of the constituent material, and the like. Therefore, development of a means for analyzing the stress distribution caused by the temperature distribution or the external pressure without performing a test has been demanded.

However, when applying a finite element analysis method for analyzing the stress distribution in the honeycomb structure, since the honeycomb structure has a three-dimensional structure in which many minute cells are assembled, the amount of calculation is increased to a large extent and it is difficult to deal with such a large amount of calculation using commercially-available computer software and hardware. A supercomputer may perform such a calculation, but even that requires a long period of time. Moreover, such an investment increases the product cost, whereby competitiveness is weakened.

Prior art literature as to the means for analyzing the stress distribution inside the cell structure such as the honeycomb structure has not been found. As prior art literature dealing with a structural analysis of a structure in general, “Japan Society of Mechanical Engineers papers (A) Vol. 66, No. 642 (2000-2), paper No. 99-0312, pp. 14-20 (hereinafter called “non-patent document 1”)” proposes an efficient numerical analysis technique for a structure with local heterogeneity. In more detail, when analyzing a structure with local heterogeneity, it is necessary to determine not only deformation of the entire structure, but also the stress distribution near the heterogeneity, and the entire structure must be subdivided if modeling of the local region is given priority, whereby the data creation time and the calculation cost are increased to an impractical level. However, the non-patent document 1 suggests that this problem can be resolved by analyzing the local heterogeneity using a finite element mesh superposition method, and analyzing the remaining structure by a finite element method using a shell-solid connection in which the entire structure is modeled using the shell elements and the vicinity of the heterogeneity is modeled using the solid elements.

However, the means and the analytical example disclosed in the non-patent document 1 can be applied only when the region which requires a detailed analysis (local heterogeneity in the non-patent document 1 and the copper region in the tungsten plate in the analytical example) has been determined in advance. Therefore, it is difficult to apply the means disclosed in the non-patent document 1 as the means for analyzing the stress distribution which occurs inside the honeycomb structure used as a catalyst substrate or a filter when a temperature change occurs inside the honeycomb structure or pressure is applied from the outside. This is because the heterogeneity cannot be determined in advance since the stress distribution may change depending on the internal temperature change or the external pressure.

### SUMMARY OF THE INVENTION

The present invention has been achieved in view of the above-described situation. An objective of the present invention is to provide a means for analyzing the stress distribution in the cell structure caused by the internal temperature distribution or external pressure which can be realized by using general-purpose computer software and hardware without performing a simulation test and making a large investment. As a result of extensive studies, it was found that the above objective can be achieved by the means as described below.

Specifically, according to the present invention, there is provided a method for analysis of a cell structure for analyzing stress which occurs inside the cell structure due to a temperature distribution which occurs inside the cell structure or pressure applied from outside of the cell structure, the cell structure being in a shape of a tubular body including two end faces and a body face which connects the two end faces, a plurality of cells partitioned by wall sections being formed inside the tubular body in an axial direction of the tubular body, and the cell structure including a repeating structure formed by the wall sections and the cells, the method comprising: an analysis step which includes replacing the cell structure or a part of the cell structure with an anisotropic solid body having property values of equivalent rigidity characteristics, creating a finite element model of the anisotropic solid body based on the property values, applying an internal temperature distribution or an external pressure to the finite element model of the anisotropic solid body, and calculating the stress to obtain a stress distribution in the anisotropic solid body.

The structural analysis used herein refers to calculating the stress in each section of the cell structure (or part of the cell structure) or the stress distribution or deformation over the entire cell structure (or part of the cell structure) based on a given condition. The given condition is the internal temperature distribution (may be simply referred to as “temperature distribution”) or the external pressure. The temperature distribution or the external pressure may be applied to the finite element model using a conventional means according to the finite element method. The temperature distribution which occurs inside the cell structure is a nonuniform temperature distribution caused by a thermal load, and indicates the temperature distribution when a partial or nonuniform temperature change occurs inside the cell structure. The amount and the distribution of the stress change in accordance with the change in the temperature distribution when the temperature distribution changes. The anisotropic solid body means a formed product having the same external shape as the external shape of the structural analysis target cell structure, but the filled cells, and of which the properties vary, depending on the direction.

In the method for analysis of a cell structure according to the present invention, the part of the cell structure replaced with the anisotropic solid body is preferably a piece obtained by equally dividing the entire cell structure into two, four, or eight. Specifically, the number of divisions is preferably at most three such as 2, 4, or 8. The number of divisions is the number limited to realize division in which each divided cell structure has a similar shape in a cell structure which is in the shape of a circular tube and in which the cell shape has symmetry. The number of divisions is further limited in a cell structure in the shape of a tube of which the cross section perpendicular to the axial length is elliptical, in which the number of divisions is two or four, specifically, the part of the cell structure replaced with the anisotropic solid body is preferably a piece obtained by equally dividing the entire cell structure into two or four.

In the method for analysis of a cell structure according to the present invention, it is preferable that the rigidity characteristics of the anisotropic solid body in the analysis step be expressed by the following numerical equation (1).

$$( \begin{matrix}σ x \\ σ y \\ σ z \\ τ xy \\ τ yz \\ τ zx\end{matrix} ) = ( \begin{matrix}K11 & K12 & K13 & 0 & 0 & 0 \\ K21 & K22 & K23 & 0 & 0 & 0 \\ K31 & K32 & K33 & 0 & 0 & 0 \\ 0 & 0 & 0 & K44 & 0 & 0 \\ 0 & 0 & 0 & 0 & K55 & 0 \\ 0 & 0 & 0 & 0 & 0 & K66\end{matrix} ) ( \begin{matrix}ɛ x \\ ɛ y \\ ɛ z \\ γ xy \\ γ yz \\ γ zx\end{matrix} ) \qquad ( 1 )$$

θx: X-axis direction normal stress, σy: Y-axis direction normal stress, σz: Z-axis direction (honeycomb passage direction) normal stress,
τxy: Y-axis direction shear stress in a plane perpendicular to the X axis, τyz: Z-axis direction shear stress in a plane perpendicular to the Y axis, τzx: X-axis direction shear stress in a plane perpendicular to the Z axis,
εx: X-axis direction tensile (or compression) strain, εy: Y-axis direction tensile (or compression) strain, εz: Z-axis direction tensile (or compression) strain,
γxy: XY inplane shear strain, γyz: YZ inplane shear strain, γzx: XY inplane shear strain, K11, K12, K13, K21, K22, K23, K31, K32, K33, K44, K55, and K66: moduli of elasticity.

The numerical equation (1) indicates the relationship between the stress and the strain. In the numerical equation (1), the left side indicates the stress, the right term in the right side indicates the strain, and the left term in the right side indicates the modulus of elasticity matrix. The modulus of elasticity matrix is indicated as the matrix containing 12 moduli of elasticity as the components. In the left side, the component indicated by σ indicates the normal stress, and the component indicated by τ indicates the shear stress. In the right term in the right side, the component indicated by ε indicates the tensile (or compression) strain, and the component indicated by γ indicates the shear strain. The moduli of elasticity K11, K22, and K33 are Young's moduli, and the moduli of elasticity K44, K55, and K66 correlate to the shear modulus. As reference literature for the description in this paragraph, “Cellular Solids—Structure & Properties, first edition (Jun. 30, 1993), publisher: Uchida Rokakuho Publishing Co., Ltd., author: L. J. Gibson and M. F. Ashby, translator: Masayuki Otsuka, pp. 475-482” can be given.

The shear stress and the shear strain are described below using an example shown in FIG. 17. When a shear force F acts in the X-axis direction on the upper surface of an object in the shape of a rectangular parallelepiped having an upper surface area of A and a height of L disposed in the coordinate system shown in FIG. 17, an X-axis direction shear stress τyx=F/A in a plane perpendicular to the Y axis occurs in the object, and an XY inplane shear strain γxy is λ/L.

The numerical equation (1) may be derived by creating a finite element model as one unit of the cell structure or the part of the cell structure which can be considered to be the repeating structure, calculating the amount of displacement at a representative point by applying an external pressure to the finite element model in a plurality of directions, and calculating each of the moduli of elasticity based on the external pressure and the amount of displacement. The element in which the amount of displacement or the stress calculated together with the amount of displacement is maximum may be used as the representative point, although the representative point is not limited thereto. The numerical equation (1) may be derived using a homogenization method.

The method for analysis of a cell structure according to the present invention preferably includes a local stress evaluation step of evaluating local stress inside the cell structure based on a value of stress E2 calculated using the following numerical equation (2).
E2=C1σ₁x+C2σ₁y+C3σ₁z+C4τ₁xy+C5τ₁zx+C6τ₁yz (2)
σ₁x: X-axis direction normal stress calculated in the analysis step, σ₁y: Y-axis direction normal stress calculated in the analysis step, σ₁z: Z-axis direction (honeycomb passage direction) normal stress calculated in the analysis step,
τ₁xy: Y-axis direction shear stress in a plane perpendicular to the X axis calculated in the analysis step, τ₁zx: X-axis direction shear stress in a plane perpendicular to the Z axis calculated in the analysis step, τ₁yz: Z-axis direction shear stress in a plane perpendicular to the Y axis calculated in the analysis step,
C1: influence weighting factor of the X-axis direction normal stress σ₁x, C2: influence weighting factor of the Y-axis direction normal stress σ₁y, C3: influence weighting factor of the Z-axis direction normal stress σ₁z, C4: influence weighting factor of the Y-axis direction shear stress τ₁xy in a plane perpendicular to the X axis, C5: influence weighting factor of the X-axis direction shear stress τ₁zx in a plane perpendicular to the Z axis, and C6: influence weighting factor of the Z-axis direction shear stress τ₁yz in a plane perpendicular to the Y axis.

In the numerical equation (2), the values C1 to C6 differ depending on the thickness of the wall section (partition wall), the cell pitch, and the Young's modulus and the Poisson ratio of the material for the cell structure. The numerical equation (2) may be derived by creating a finite element model as one unit of the cell structure or the part of the cell structure which can be considered to be the repeating structure, calculating the stress at a representative point by applying an external pressure to the finite element model in a plurality of directions, and calculating each of the influence weighting factors based on the external pressure and the stress. The element in which the stress calculated is maximum may be used as the representative point, although the representative point is not limited thereto.

In the method for analysis of a cell structure according to the present invention, when deriving the numerical equation (1) or deriving the numerical equation (2), it is preferable that the number of element divisions in the thickness direction be two or more in the wall section in the finite element model as the cell structure. The number of element divisions in the thickness direction in the wall section is more preferably three or more, and still more preferably four or more.

When deriving the numerical equation (1) or deriving the numerical equation (2), it is preferable that the number of element divisions be two or more in a wall intersection curved section in the finite element model as the cell structure. The number of element divisions in the wall intersection curved section is more preferably three or more, and still more preferably four or more.

According to the present invention, there is provided a cell structure of which a stress distribution has been analyzed by using the above-described method for analysis of a cell structure, the cell structure having a material fracture stress value greater than a maximum value of the stress which occurs inside the cell structure due to the temperature distribution which occurs inside the cell structure or the pressure applied from outside of the cell structure.

Since the method for analysis of a cell structure according to the present invention determines the stress distribution by creating the finite element model of the anisotropic solid body equivalent to the cell structure, the amount of calculation required for the stress calculation can be significantly reduced. This is because the number of elements, the number of nodes, and the number of degrees of freedom of the finite element model are significantly reduced. In the case where the number of elements, the number of nodes, and the number of degrees of freedom of the entire cell structure amount to several tens of millions, the number of elements, the number of nodes, and the number of degrees of freedom of the equivalent anisotropic solid body may amount to several tens of thousands, although the numbers may differ depending on the conditions such as the cell pitch and the wall thickness of the cell structure.

If the target replaced with the anisotropic solid body is the part of the cell structure which is a piece obtained by equally dividing the entire cell structure into two, four, or eight, which is the preferable mode of the present invention, the number of elements, the number of nodes, and the number of degrees of freedom of the finite element model can be further reduced in comparison with the case of replacing the entire cell structure with the anisotropic solid body, whereby the amount of stress calculation is reduced.

Therefore, the stress can be calculated by using commercially-available general-purpose computer software and hardware, and the time required for the processing is significantly reduced. This makes it unnecessary to make an investment in an extremely high performance computer. Since the simulation can be repeatedly performed while changing the internal temperature distribution or the external pressure, the ratio of the internal temperature distribution or the external pressure to the stress at which cracks may occur in the cell structure can be quantified based on the use condition without using a simulation test, whereby a cell structure optimum for the application can be manufactured.

In the method for analysis of a cell structure according to the present invention, since the local stress in the cell structure is evaluated based on the stress distribution in the anisotropic solid body equivalent to the cell structure, it is unnecessary that the region which requires a detailed analysis (corresponding to the local heterogeneity in the non-patent document 1) be determined in advance differing from the non-patent document 1. Therefore, the method for analysis of a cell structure according to the present invention may be applied as a means for efficiently and quickly analyzing the stress inside the cell structure used as a catalyst substrate or a filter of which the distribution varies when a temperature change occurs inside the cell structure or pressure is applied from the outside.

In the method for analysis of a cell structure according to the present invention, the stress distribution is determined by creating the finite element model of the anisotropic solid body which is equivalent to the cell structure and is preferably expressed using the numerical equation (1) so that the amount of calculation is reduced, and the local stress over the entire cell structure is preferably evaluated by applying the result to the numerical equation (2). Since the numerical equation (1) or the numerical equation (2) is derived by setting the number of element divisions in the thickness direction to preferably two or more in the wall section in the finite element model as the cell structure, the stress concentration on the surface of the wall section can be accurately detected. If the number of element divisions is less than two, the stress concentration on the surface of the wall section may not be accurately detected.

Likewise, since the numerical equation (1) or the numerical equation (2) is derived by setting the number of element divisions to preferably two or more in the wall intersection curved section in the finite element model as the cell structure, the stress distribution is determined by creating the finite element model of the anisotropic solid body which is equivalent to the cell structure and is preferably expressed using the numerical equation (1) so that the amount of calculation is reduced, and the local stress over the entire cell structure is preferably evaluated by applying the result to the numerical equation (2). Therefore, the predictive accuracy of the stress value in the wall intersection curved section is excellent. If the number of element divisions is less than two, the predictive accuracy of the stress value in the wall intersection curved section may deteriorate.

Since the cell structure according to the present invention has been subjected to a stress distribution analysis by using the method for analysis of a cell structure according to the present invention and has a material fracture stress value greater than the maximum value of the stress which occurs inside the cell structure due to the temperature distribution which occurs inside the cell structure or the pressure applied from outside, the cell structure rarely breaks during the actual use.

### BRIEF DESCRIPTION OF THE DRAWINGS

FIG. 1(a) is a side view showing an example of a unit structure portion of a cell structure (honeycomb structure) according to a method for analysis of a cell structure according to the present invention, and FIG. 1(b) is a diagram showing an example of a finite element model of the unit structure portion shown in FIG. 1(a).

FIG. 2 is an oblique diagram showing a honeycomb structure as an example of a cell structure.

FIG. 3 is an oblique diagram showing a honeycomb structure obtained by dividing the honeycomb structure shown in FIG. 2 into eight.

FIG. 4(a) is a photograph showing a finite element model of an anisotropic solid body which has replaced the honeycomb structure shown in FIG. 3, and FIG. 4(b) is a partially enlarged diagram of the finite element model shown in FIG. 4(a).

FIG. 5 is a photograph showing the temperature distribution in a quarter finite element model based on the finite element model shown in FIGS. 4(a) and 4(b).

FIG. 6(a) is a photograph showing the stress distribution in an anisotropic solid body which has replaced the honeycomb structure shown in FIG. 3, FIG. 6(b) is a photograph showing the stress distribution in the anisotropic solid body which has replaced the honeycomb structure shown in FIG. 3, FIG. 6(c) is a photograph showing the stress distribution in the anisotropic solid body which has replaced the honeycomb structure shown in FIG. 3, and FIG. 6(d) is a photograph showing the stress distribution in the anisotropic solid body which has replaced the honeycomb structure shown in FIG. 3.

FIG. 7 is an example of an oblique diagram showing a value of stress E2 calculated using the numerical equation (2) as a distribution map.

FIG. 8 is an oblique diagram showing the distribution of the stress E2 calculated using the numerical equation (2) according to a local stress evaluation in an example.

FIG. 9 is a photograph showing a finite element model of a honeycomb structure in Comparative Example 1.

FIG. 10 is a photograph showing a finite element model of an anisotropic solid body which has replaced a honeycomb structure in Example 1.

FIG. 11 is a photograph showing the temperature distribution applied to the finite element model shown in FIG. 10.

FIG. 12 is a photograph showing the stress distribution in the anisotropic solid body which has replaced the honeycomb structure in Example 1.

FIG. 13 is a photograph showing the maximum principal stress distribution in the honeycomb structure in Comparative Example 1.

FIG. 14 is an oblique diagram showing a monolith structure as an example of a cell structure.

FIG. 15(a) is an enlarged diagram showing the shape and arrangement of cells in a plane perpendicular to the axial direction of a tubular body in a monolith structure, FIG. 15(b) is an enlarged diagram showing the shape and arrangement of cells in a plane perpendicular to the axial direction of a tubular body in a monolith structure, FIG. 15(c) is an enlarged diagram showing the shape and arrangement of cells in a plane perpendicular to the axial direction of a tubular body in a monolith structure, and FIG. 15(d) is an enlarged diagram showing the shape and arrangement of cells in a plane perpendicular to the axial direction of a tubular body in a monolith structure.

FIG. 16(a) is an enlarged diagram showing the shape of cells in a plane perpendicular to the axial direction of a tubular body in a honeycomb structure, FIG. 16(b) is an enlarged diagram showing the shape of cells in a plane perpendicular to the axial direction of a tubular body in a honeycomb structure, FIG. 16(c) is an enlarged diagram showing the shape of cells in a plane perpendicular to the axial direction of a tubular body in a honeycomb structure, and FIG. 16(d) is an enlarged diagram showing the shape of cells in a plane perpendicular to the axial direction of a tubular body in a honeycomb structure.

FIG. 17 is a schematic diagram illustrative of the shear stress and the shear strain.

### DESCRIPTION OF PREFERRED EMBODIMENT

Embodiments of the method for analysis of a cell structure according to the present invention are described below in detail with reference to the drawings. However, the present invention should not be construed as being limited to the following embodiments. Various alterations, modifications, and improvements may be made within the scope of the present invention based on knowledge of a person skilled in the art. For example, although the drawings show preferred embodiments of the present invention, the present invention is not limited to modes shown in the drawings or to information shown in the drawings. Although means similar to or equivalent to means described in the present specification may be applied when carrying out or verifying the present invention, preferable means are means as described below.

A cell structure according to the present invention, which is the target of the method for analysis of a cell structure according to the present invention, is described below. The cell structure according to the present invention satisfies the following necessary conditions 1) to 3).

1) The cell structure has an external shape in the shape of a tubular body including two end faces and a body face which connects the two end faces. This means that the external shape is tubular, and is synonymous even if the external shape is expressed as pillar-shaped. The concrete external shape is not limited. The shape of the end face or the cross-sectional shape perpendicular to the axial direction of the tubular body may be square, rectangular, another quadrilateral, circular, elliptical, another shape drawn by a curve, triangular, polygonal with four or more sides, a composite shape consisting of a curve and a straight line, or the like.

2) The cell structure includes a plurality of cells partitioned by wall sections which are formed inside the tubular body in the axial direction of the tubular body. Specifically, the cell structure is neither a hollow tube nor a solid pillar, but is tubular in which the cells are formed and the cells are generally open on the end faces. The axial direction of the tubular body corresponds to the direction which connects the two end faces. The shape of the cells is not limited. The shape of the cells in a plane perpendicular to the axial direction of the tubular body may be square, rectangular, another quadrilateral, circular, elliptical, another shape drawn by a curve, triangular, polygonal with four or more sides, a composite shape consisting of a curve and a straight line, or the like.

3) The cell structure includes a repeating structure formed by the wall sections and the cells. This also includes the case where, when the cell structure is divided into two or more sections along a plane in the axial direction of the tubular body, each divided section becomes an identical structure. In this case, each divided section is one unit of the repeating structure. Although all the divided sections are not necessarily identical, most of the divided sections preferably have an identical structure and shape. The shape of the cells partitioned by the wall sections in one unit is not limited, and cells having various shapes may exist. Specifically, a plurality of cells in the shape of a square, rectangle, another quadrilateral, circle, ellipse, another shape drawn by a curve, triangle, polygon with four or more sides, composite shape consisting of a curve and a straight line, or the like may be included in one unit in a plane perpendicular to the axial direction of the tubular body.

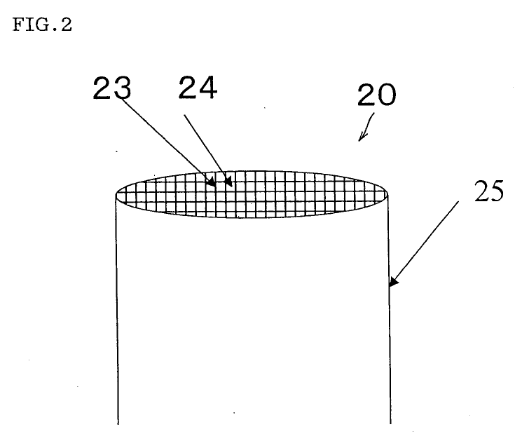

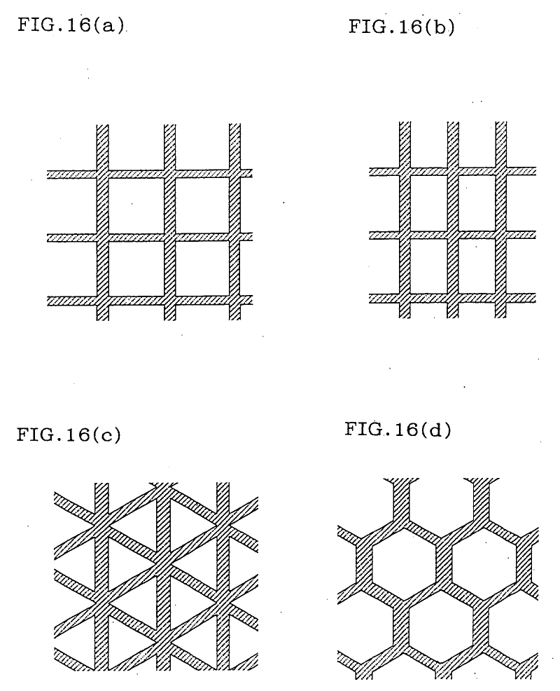

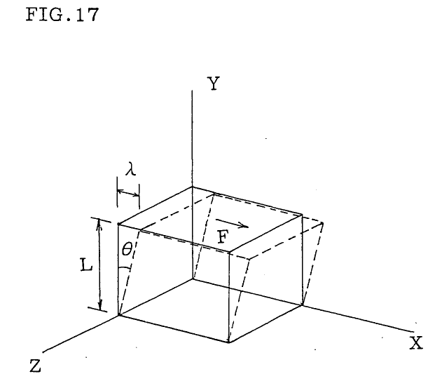

A honeycomb structure can be given as an example of the cell structure according to the present invention. FIG. 2 is an oblique diagram showing a honeycomb structure as an example of the cell structure. FIGS. 16(a), 16(b), 16(c), and 16(d) are enlarged diagrams showing the shape of the cells in a plane perpendicular to the axial direction of the tubular body, the shape of the cells being square (FIG. 16(a)), rectangular (FIG. 16(b)), triangular (FIG. 16(c)), and hexagonal (FIG. 16(d)). A honeycomb structure 20 shown in FIG. 2 includes an outer wall 25 which forms the body face, partition walls 23 as the wall sections disposed inside the outer wall 25, and a plurality of cells 24 partitioned by the partition walls 23, and is formed by the repeating structure consisting of the partition walls 23 and the cells 24. In the honeycomb structure 20, the shape of the cells (shape of the cells open on the end face) is square as shown in FIG. 16(a), and one unit of the repeating structure consists of one cell 24 and the partition walls 23 which form (partition) the cell 24.

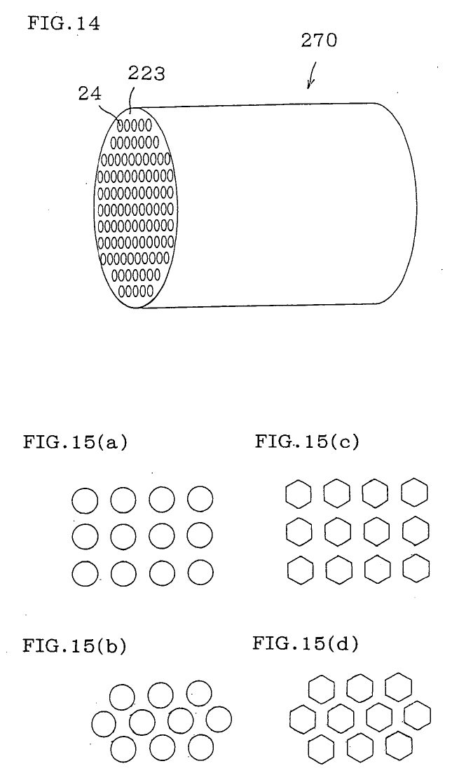

A monolith structure can be given as another example of the cell structure according to the present invention. FIG. 14 is an oblique diagram showing an example of a monolith structure as the cell structure, and FIGS. 15(a), 15(b), 15(c), and 15(d) are enlarged diagrams showing the shape and the arrangement of the cells in a plane perpendicular to the axial direction of the tubular body, the cells being circular and disposed in a lattice arrangement (FIG. 15(a)), circular and disposed in a checkered flag pattern arrangement (FIG. 15(b)), hexagonal and disposed in a lattice arrangement (FIG. 15(c)), and hexagonal and disposed in a checkered flag pattern arrangement (FIG. 15(d)). A monolith structure 270 shown in FIG. 14 includes an integral wall section 223 which forms the body face and the end faces, and a plurality of cells 24 formed through the wall section 223, and is formed by the repeating structure consisting of the wall section 223 and the cells 24. In the monolith structure 270, the shape and the arrangement of the cells (shape and arrangement of the cells open on the end face) are respectively circular and a lattice arrangement as shown in FIG. 15(a), and one unit of the repeating structure consists of one cell 24 and a part of the wall section 223 which forms the cell 24.

An analysis step of the structural analysis method is described below. The method for analysis of a cell structure according to the present invention is a method of analyzing the stress distribution which occurs inside the cell structure due to the temperature distribution which occurs inside the cell structure. The honeycomb structure 20 shown in FIG. 2 as an example of the cell structure is in the shape of a tubular body, has a circular horizontal cross section (plane perpendicular to the axial direction of the tubular body) in FIG. 2, and has a cell structure including the outer wall 25 and a number of cells 24 formed by the partition walls 23 inside the outer wall 25.

For example, when causing a catalyst to be carried on the partition walls 23 of the honeycomb structure 20 and using the honeycomb structure 20 as a catalyst substrate for an exhaust gas purification device or the like, high-temperature exhaust gas passes through the cells to apply heat to the honeycomb structure 20, and the temperature of only the center section is generally locally increased, whereby a nonuniform temperature distribution is formed. Since all the partition walls 23 including the outer wall 25 are connected to restrict one another, cracks may occur in the partition wall 23 or the outer wall 25 due to occurrence of different degrees of stress in each section caused by different temperatures in each section. The method for analysis of a cell structure according to the present invention analyzes the stress distribution which occurs inside the honeycomb structure as an example of the cell structure due to the internal temperature distribution or the external pressure applied to the honeycomb structure by using a finite element method to enable a section in which cracks tend to occur to be specified without performing a simulation test.

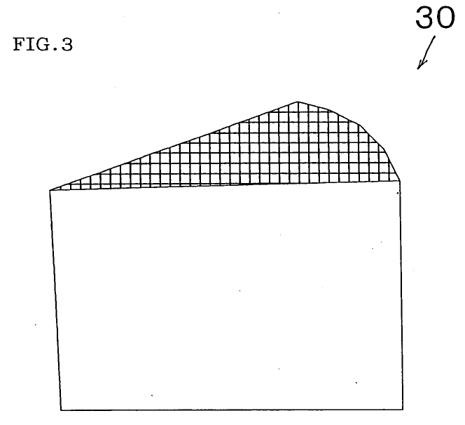

First, the honeycomb structure as an example of the cell structure is replaced with an anisotropic solid body having property values of equivalent rigidity characteristics. Since the cross section of the honeycomb structure 20 is circular, the replacement target may be a part of the honeycomb structure 20 obtained by dividing the honeycomb structure 20 shown in FIG. 2 into eight instead of the entire honeycomb structure 20. FIG. 3 is an oblique diagram showing a honeycomb structure 30 in the shape of a tubular body having a fan-shaped cross section which is obtained by dividing the honeycomb structure 20 into eight.

When replacing the honeycomb structure 30 with an anisotropic solid body having property values of equivalent rigidity characteristics, the rigidity characteristics of the anisotropic solid body are expressed by the above numerical equation (1). Each term in the numerical equation (1) is calculated as follows.

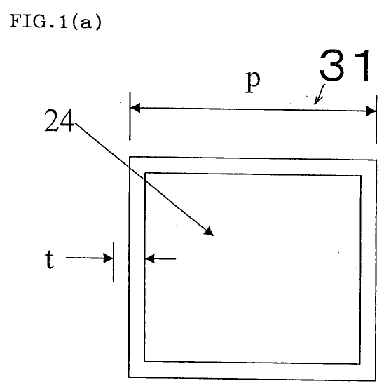

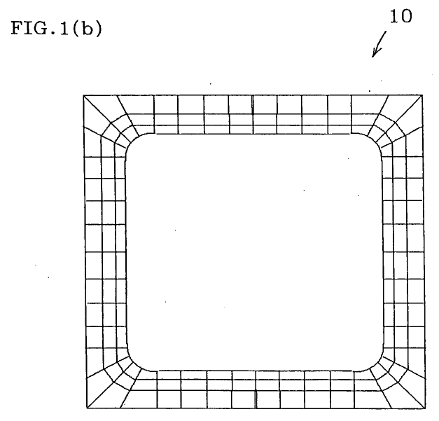

A finite element model as one unit of the cell structure of the honeycomb structure 30 which can be considered to be the repeating structure is created. FIG. 1(a) is a side view showing a unit structure portion (one cell and partition walls (wall sections) which form the cell) which is a part of the honeycomb structure 30, which is a part of the honeycomb structure 20 as the structural analysis target, and is one unit which can be considered to be the repeating structure, and FIG. 1(b) is a side view showing a finite element model of the unit structure portion. In the unit structure portion 31 (honeycomb structure 30) shown in FIG. 1(a), the cells 24 are formed at a partition wall thickness of t and a cell pitch of p. The number of element divisions in the thickness direction is three in the partition wall (wall section) in the finite element model 10 shown in FIG. 1(b), and the number of element divisions is four in a partition wall intersection curved section corresponding to the wall intersection curved section.

After providing a Young's modulus E and a Poisson ratio ν as conditions for mechanical properties of the material which forms the unit structure portion 31 (honeycomb structure 30), a stress analysis is performed for six cases where σx, σy, σz, τxy, τyz, and τzx are individually applied to the finite element model 10 shown in FIG. 1(b) on the outermost circumferential surface of the finite element model as the external pressure (load) in a plurality of directions or the shear stress along a plane, whereby outputs εx, εy, εz, γxy, γyz, and γzx are respectively obtained. Substituting these outputs in the numerical equation (1) yields each term in the numerical equation (1) as the solution of the simultaneous equations.

A homogenization method may be used as another method for calculating each term in the numerical equation (1). After providing the Young's modulus E and the Poisson ratio v as the mechanical properties of the material which forms the unit structure portion 31 (honeycomb structure 30), an equation obtained by descretizing the finite element model 10 of the unit structure portion 31 is calculated based on the idea of the homogenization method. When the honeycomb structure 30 (FIG. 3) is formed by the repeated arrangement of the unit structure portions 31, each term in the numerical equation (1) can be directly calculated from the discretized equation by taking into consideration the entire relationship between the adjacent elements of two adjacent unit structure portions 31 due to repetition of the unit structure portions 31.

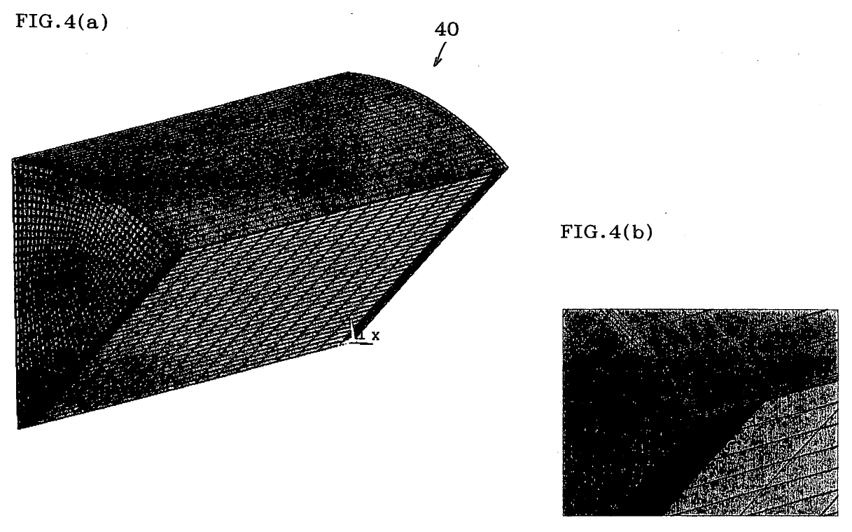

A finite element model of the anisotropic solid body of the honeycomb structure 30 is created based on the numerical equation (1). FIG. 4(a) is a photograph showing the finite element model, and FIG. 4(b) is a partially enlarged photograph. The thin lines of a finite element model 40 shown in FIGS. 4(a) and 4(b) indicate element divisions. If the element size is appropriately set (about 0.1 to 10 mm), the number of elements is significantly reduced in comparison with the case of directly creating a finite element model of the honeycomb structure 30 as the honeycomb structure, and the number of nodes and the number of degrees of freedom are also significantly reduced.

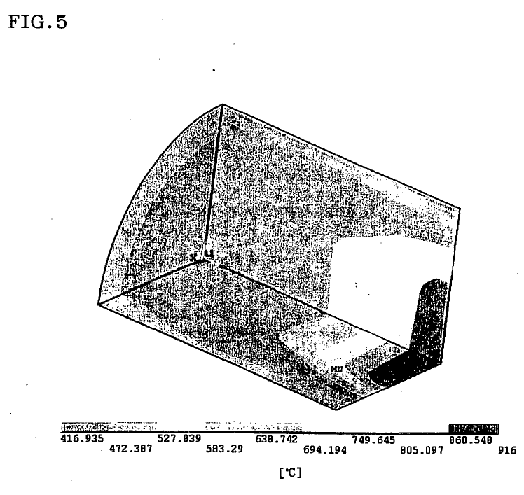

A temperature distribution is applied to the finite element model 40. FIG. 5 is a photograph showing the temperature distribution applied to a quarter finite element model based on the one-eighth finite element model 40. It suffices to apply a temperature to each node of the finite element model based on the actual use condition.

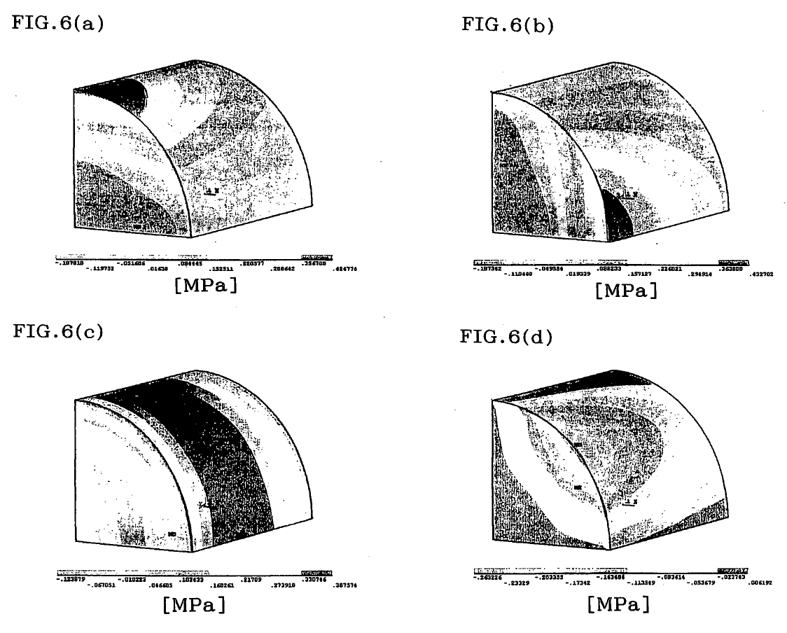

The stress is calculated by performing a finite element analysis based on the applied temperature distribution to obtain the stress distribution. FIGS. 6(a), 6(b), 6(c), and 6(d) are photographs showing the stress distribution in the anisotropic solid body which has replaced the honeycomb structure 30, FIG. 6(a) showing the distribution of the resulting X-axis direction normal stress σ₁x, FIG. 6(b) showing the distribution of the resulting Y-axis direction normal stress σ₁y, FIG. 6(c) showing the distribution of the resulting Z-axis direction normal stress σ₁z, and FIG. 6(d) showing the distribution of the resulting Y-axis direction shear stress τ₁xy in a plane perpendicular to the X axis (distribution of the X-axis direction shear stress in a plane perpendicular to the Z axis and distribution of the Z-axis direction shear stress in a plane perpendicular to the Y axis are omitted). In the present invention, since the stress distribution in the honeycomb structure 30 and the stress distribution in the anisotropic solid body which has replaced the honeycomb structure 30 correlate to each other, the stress distribution in the honeycomb structure 30 can be calculated based on the stress distribution determined for the anisotropic solid body.

A local stress evaluation step is described below. The local stress evaluation step is a step of evaluating the local stress as the honeycomb structure (cell structure) based on the stress distribution in the anisotropic solid body obtained by the above-described analysis step. In the local stress evaluation, it is preferable to evaluate the local stress using the value calculated using the numerical equation (2) based on the value of the stress at each position in each direction obtained by the analysis step.

The values of the influence weighting factors C1 to C6 in the numerical equation (2) differ depending on the partition wall thickness t, the cell pitch p, the Young's modulus and the Poisson ratio of the material, and the type of the evaluation target local stress, and calculated as described below. As the evaluation target local stress, the XY inplane maximum principal stress and the Z-axis direction principal stress can be given.

A finite element model as one unit of the cell structure (unit structure portion) of the honeycomb structure 30 which can be considered to be the repeating structure is created in the same manner as in the case of deriving the numerical equation (1) (see FIG. 1(a)). FIG. 1(b) is a side view showing the finite element model of the unit structure portion. A stress analysis is performed by individually applying σx, σy, σz, τxy, τyz, and τzx to the finite element model 10 shown in FIG. 1(b) on the outermost circumferential surface of the finite element model as the external pressure (load) in a plurality of directions or the shear stress along a plane (six cases), whereby the XY inplane maximum principal stress distribution and the Z-axis direction principal stress distribution in the finite element model are obtained. If E3 occurs as the maximum value of the maximum principal stress distribution when applying the X-axis direction normal stress σx, C1 is calculated by E3/σx when the XY inplane maximum principal stress is the evaluation target. If E4 occurs as the maximum value of the Z-axis direction principal stress distribution when applying the X-axis direction normal stress σx, C1 is calculated by E4/σx when the Z-axis direction principal stress is the evaluation target. The numerical equation (2) is derived by calculating all the influence weighting factors in the same manner as described above. In the local stress evaluation, the numerical equation (2) including the same influence weighting factors C1 to C6 may be used when the honeycomb structure has the same partition wall thickness t, cell pitch p, Young's modulus E, and Poisson ratio ν, and the type of the evaluation target local stress is the same. When the evaluation target is the XY inplane maximum principal stress approximately as the evaluation local stress for a number of cell structures, C5 and C6 may be zero. When the evaluation target is the Z-axis direction principal stress approximately as the evaluation local stress for a number of cell structures, C4, C5, and C6 may be zero.

The local stress evaluation as the honeycomb structure is performed by calculating the local stress for each element by substituting the stress value in the anisotropic solid body obtained by the analysis step into the numerical equation (2), and using the calculated value E2. As the concrete evaluation means, a method of displaying the calculated value E2 as a distribution map, and visually evaluating the local stress can be given. FIG. 7 shows an example.

The present invention is described below in more detail based on examples. However, the present invention is not limited to the following examples.

### EXAMPLE 1

A tubular honeycomb structure B having a circular cross-sectional shape was provided (not shown). The honeycomb structure B had a cross-sectional diameter of 20 mm and an axial length (height) of 10 mm. The cell pitch was 1.47 mm, the partition wall thickness was 0.2 mm, and the radius of curvature at the partition wall intersection was 0.5 mm.

A quarter piece of the honeycomb structure B was replaced with an anisotropic solid body having equivalent rigidity characteristics using the numerical equation (1). As the normalized mechanical properties of the honeycomb structure B at 25° C., a Young's modulus of 15, a Poisson ratio of 0.25, and a coefficient of thermal expansion of 1×10⁻⁶ were used for the partition wall, and a Young's modulus of 1, a Poisson ratio of 0.25, and a coefficient of thermal expansion of 1×10⁻⁶ were used for the outer wall.

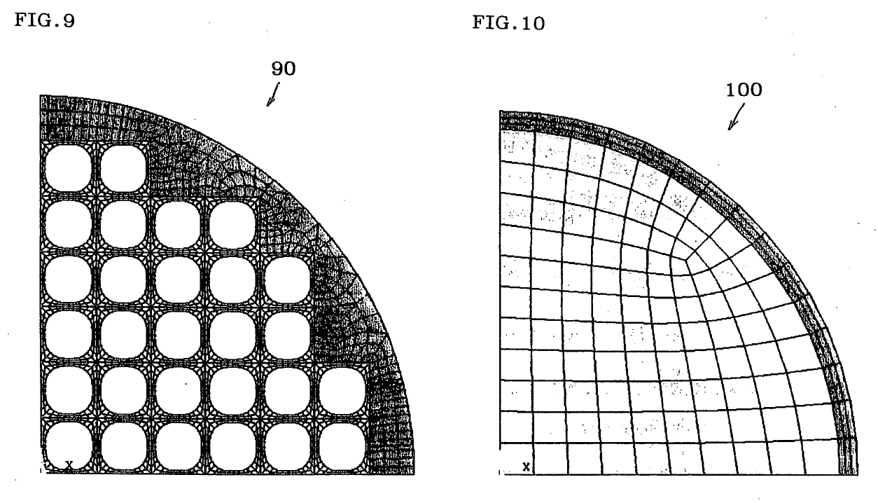

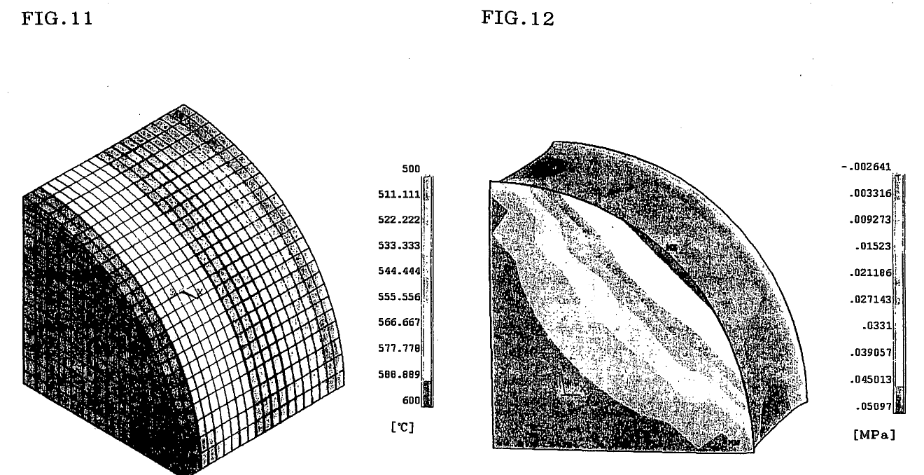

A finite element model of the replacement anisotropic solid body was created. FIG. 10 is a photograph showing the finite element model of the replacement anisotropic solid body. The thin lines shown in a finite element model 100 shown in FIG. 10 indicate elements, and the number of elements is small in comparison with a finite element model 90 (see FIG. 9) as the honeycomb structure in Comparative Example 1 as described later. The finite element model 100 is the model when the element size was set at 0.1 to 2 mm, in which the number of elements was about 5,000, the number of nodes was about 6,000, and the number of degrees of freedom was about 20,000. After applying a temperature distribution, the stress was calculated to obtain the stress distribution. FIG. 11 is a photograph showing the applied temperature distribution. The applied temperature distribution was in the range of about 500 to 600° C. FIG. 12 is a photograph showing the τ₁xy stress distribution as a result of the stress analysis step for the finite element model of the anisotropic solid body. A similar distribution map was obtained for σ₁x: X-axis direction normal stress, σ₁y: Y-axis direction normal stress, σ₁z: Z-axis direction (honeycomb passage direction) normal stress, τ₁zx: X-axis direction shear stress in a plane perpendicular to the Z axis, and τ₁zy: Z-axis direction shear stress in a plane perpendicular to the Y axis (not shown).

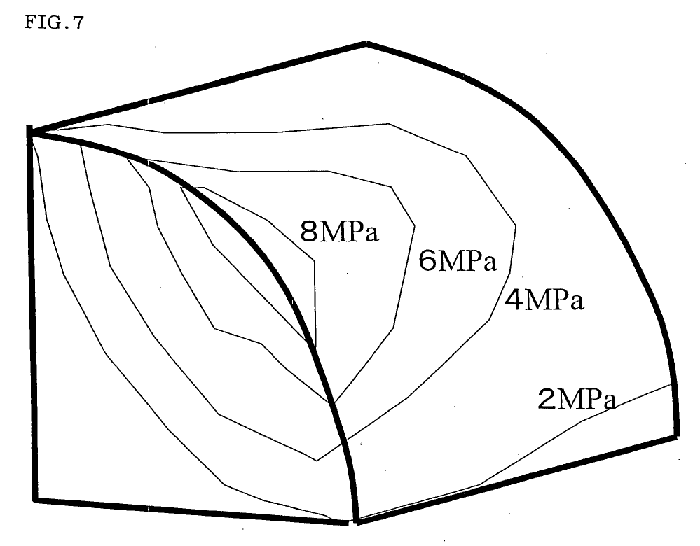

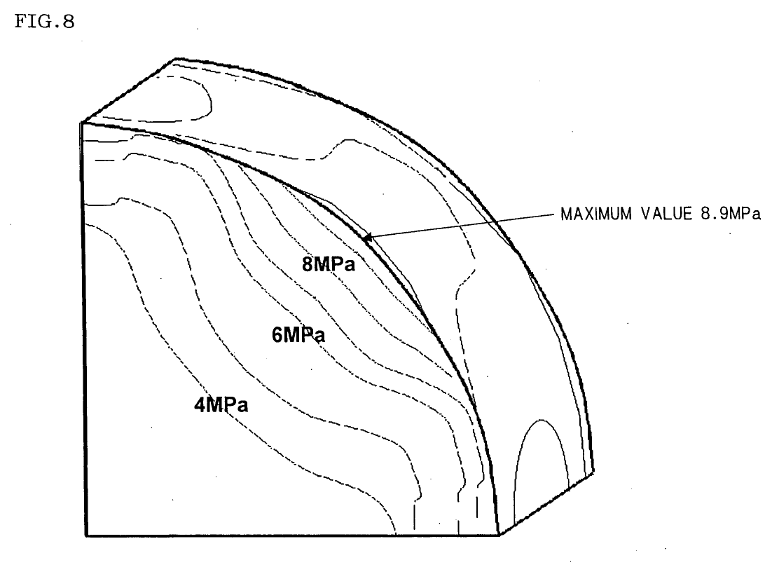

The local stress was evaluated. In this example, each coefficient in the numerical equation (2) when the evaluation target was the XY inplane maximum principal stress was C1=14.7, C2=14.7, C3=7.8, C4=150, C5=1.5, and C6=1.5. FIG. 8 shows the distribution of the value E2 at each point obtained by substituting σ₁x, σ₁y, σ₁z, τ₁xy, τ₁zx, and τ₁yz at each point obtained by the analysis step for the anisotropic solid body model into the numerical equation (2). The maximum value of E2 (XY inplane maximum principal stress) was 8.9 MPa. The maximum amount of outer wall deformation was 0.0069 mm. The calculation time required in Example 1 was about three minutes.

### COMPARATIVE EXAMPLE 1

The stress as the honeycomb structure was calculated using a quarter piece of the honeycomb structure B similar to that used in Example 1. Specifically, a finite element model as the quarter piece of the honeycomb structure B was created, a temperature distribution (not shown) was applied to the finite element model, and the stress was calculated to obtain the stress distribution. FIG. 9 is a photograph showing the finite element model as the quarter piece of the honeycomb structure B. A finite element model 90 shown in FIG. 9 is the model when the element size was set at 0.02 to 1 mm, in which the number of elements was about 40,000, the number of nodes was about 40,000, and the number of degrees of freedom was about 120,000.

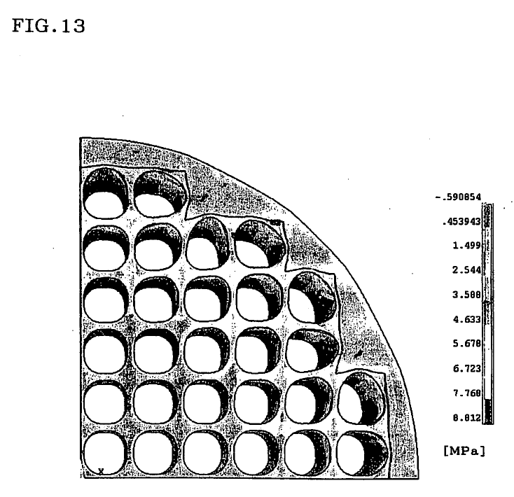

The temperature distribution was applied according to Example 1, and was in the range of about 500 to 600° C. FIG. 13 is a photograph showing the XY inplane maximum principal stress distribution. The maximum value of the XY inplane maximum principal stress was 8.8 MPa. The amount of the stress was almost the same as that in Example 1, and the position in the entire cell structure was also the same. The maximum position and the maximum value of the XY inplane maximum principal stress in the actual cell structure could be approximately estimated from the distribution of E2 (XY inplane maximum principal stress) at each position calculated using the numerical equation (2) from the stress values σ₁x, σ₁y, σ₁z, τ₁xy, τ₁zx, and τ₁yz at each position obtained by the calculation using the anisotropic solid body as the cell structure. The maximum amount of outer wall deformation in Comparative Example 1 was 0.0070 mm, which was almost equal to that in Example 1. Therefore, it is judged that almost equal stress and deformation could be calculated in Example 1 and Comparative Example 1. The calculation time required for the analysis in Comparative Example 1 was about four hours.

In Example 1 and Comparative Example 1, pressure was not applied from the outside. In general, thermal expansion (deformation) occurs when the stress occurs due to the temperature distribution (heat), whereby the internal mechanical stress may occur. Therefore, it is understood that the method for analysis of a cell structure according to the present invention not only is useful for obtaining the stress distribution caused by heat, but also may be applied to analyze the mechanical stress which occurs inside the cell structure.

In Example 1 and Comparative Example 1, a honeycomb structure (cell structure) with a diameter of about 20 mm was used. However, the actual honeycomb structure used as a catalyst substrate or a filter generally has a diameter of about 100 to 200 mm. In general, the number of degrees of freedom of the finite element model is increased approximately in units of the square of the diameter. Therefore, without the present invention, the number of degrees of freedom of the finite element model is increased by about 16 to 25 times (4×4 (square of four)=16 when the diameter is increased by four times, and 5×5 (square of five)=16 when the diameter is increased by five times) )1,920,000 to 3,000,000) when the diameter of the cell structure is 100 mm, and the number of degrees of freedom of the finite element model is increased by about 64 to 100 times (7,680,000 to 12,000,000) when the diameter of the cell structure is 200 mm. On the other hand, according to the present invention, the modeling always requires only about 20,000 degrees of freedom.

In general, since the calculation time is almost proportional to the square of the number of degrees of freedom (matrix size), the calculation time required for the analysis according to the present invention for a cell structure with a diameter of 100 to 200 mm is about several thousandths of that without the present invention.

The method for analysis of a cell structure according to the present invention is suitably used for a cell structure which is used in an environment in which a large temperature change occurs or to which pressure tends to be applied from the outside. In more detail, the structural analysis method may be suitably used to calculate the stress which may occur inside a honeycomb structure used for an exhaust gas purification device for a heat engine such as an internal combustion engine or combustion equipment such as a boiler, a liquid fuel or gaseous fuel reformer, or the like due to the internal temperature change or pressure applied from the outside.

1. A method for analysis of a cell structure for analyzing stress which occurs inside the cell structure due to a temperature distribution which occurs inside the cell structure or pressure applied from outside of the cell structure, the cell structure being in a shape of a tubular body including two end faces and a body face which connects the two end faces, a plurality of cells partitioned by wall sections being formed inside the tubular body in an axial direction of the tubular body, and the cell structure including a repeating structure formed by the wall sections and the cells, the method comprising:
an analysis step which includes replacing the cell structure or a part of the cell structure with an anisotropic solid body having property values of equivalent rigidity characteristics, creating a finite element model of the anisotropic solid body based on the property values, applying an internal temperature distribution or an external pressure to the finite element model of the anisotropic solid body, and calculating the stress to obtain a stress distribution in the anisotropic solid body.

2. The method for analysis of a cell structure as defined in claim 1, wherein the part of the cell structure replaced with the anisotropic solid body is a piece obtained by equally dividing the entire cell structure into two, four, or eight.

3. The method for analysis of a cell structure as defined in claim 1, wherein the rigidity characteristics of the anisotropic solid body in the analysis step are expressed by the following numerical equation (1):
$$( \begin{matrix}σ x \\ σ y \\ σ z \\ τ xy \\ τ yz \\ τ zx\end{matrix} ) = ( \begin{matrix}K11 & K12 & K13 & 0 & 0 & 0 \\ K21 & K22 & K23 & 0 & 0 & 0 \\ K31 & K32 & K33 & 0 & 0 & 0 \\ 0 & 0 & 0 & K44 & 0 & 0 \\ 0 & 0 & 0 & 0 & K55 & 0 \\ 0 & 0 & 0 & 0 & 0 & K66\end{matrix} ) ( \begin{matrix}ɛ x \\ ɛ y \\ ɛ z \\ γ xy \\ γ yz \\ γ zx\end{matrix} ) \qquad ( 1 )$$
σx: X-axis direction normal stress, σy: Y-axis direction normal stress, σz: Z-axis (honeycomb passage direction) direction normal stress,
τxy: Y-axis direction shear stress in a plane perpendicular to the X axis, τyz: Z-axis direction shear stress in a plane perpendicular to the Y axis, τzx: X-axis direction shear stress in a plane perpendicular to the Z axis,
εx: X-axis direction tensile (or compression) strain, εy: Y-axis direction tensile (or compression) strain, εz: Z-axis direction tensile (or compression) strain,
γxy: XY inplane shear strain, γyz: YZ inplane shear strain, γzx: ZX inplane shear strain, K11, K12, K13, K21, K22, K23, K31, K32, K33, K44, K55, and K66: moduli of elasticity.

4. The method for analysis of a cell structure as defined in claim 3, comprising: deriving the numerical equation (1) by creating a finite element model as one unit of the cell structure or the part of the cell structure which can be considered to be the repeating structure, calculating an amount of displacement at a representative point by applying an external pressure to the finite element model in a plurality of directions, and calculating each of the moduli of elasticity based on the external pressure and the amount of displacement.

5. The method for analysis of a cell structure as defined in claim 3, comprising: deriving the numerical equation (1) using a homogenization method.

6. The method for analysis of a cell structure as defined in claim 1, comprising: a local stress evaluation step of evaluating a local stress inside the cell structure based on a value of stress E2 calculated using the following numerical equation (2):
E2=C1σ₁x+C2σ₁y+C3σ₁z+C4τ₁xy+C5τ₁zx+C6τ₁yz (2)
σ₁x: X-axis direction normal stress calculated in the analysis step, σ₁y: Y-axis direction normal stress calculated in the analysis step, σ₁z: Z-axis direction (honeycomb passage direction) normal stress calculated in the analysis step,
τ₁xy: Y-axis direction shear stress in a plane perpendicular to the X axis calculated in the analysis step, τ₁zx: X-axis direction shear stress in a plane perpendicular to the Z axis calculated in the analysis step, τ₁yz: Z-axis direction shear stress in a plane perpendicular to the Y axis calculated in the analysis step,
C1: influence weighting factor of the X-axis direction normal stress σ₁x, C2: influence weighting factor of the Y-axis direction normal stress σ₁y, C3: influence weighting factor of the Z-axis direction normal stress σ₁z, C4: influence weighting factor of the Y-axis direction shear stress τ₁xy in a plane perpendicular to the X axis, C5: influence weighting factor of the X-axis direction shear stress τ₁zx in a plane perpendicular to the Z axis, and C6: influence weighting factor of the Z-axis direction shear stress τ₁yz in a plane perpendicular to the Y axis.

7. The method for analysis of a cell structure as defined in claim 6, comprising: deriving the numerical equation (2) by creating a finite element model as one unit of the cell structure or the part of the cell structure which can be considered to be the repeating structure, calculating the stress at a representative point by applying an external pressure to the finite element model in a plurality of directions, and calculating each of the influence weighting factors based on the external pressure and the stress.

8. The method for analysis of a cell structure as defined in claim 4, wherein a number of element divisions in a thickness direction is two or more in the wall section in the finite element model as the cell structure.

9. The method for analysis of a cell structure as defined in claim 7, wherein a number of element divisions in a thickness direction is two or more in the wall section in the finite element model as the cell structure.

10. The method for analysis of a cell structure as defined in claim 4, wherein a number of element divisions is two or more in a wall intersection curved section in the finite element model as the cell structure.

11. The method for analysis of a cell structure as defined in claim 7, wherein a number of element divisions is two or more in a wall intersection curved section in the finite element model as the cell structure.

12. A cell structure of which a stress distribution has been analyzed by using the method for analysis of a cell structure as defined in claim 1,
the cell structure having a material fracture stress value greater than a maximum value of the stress which occurs inside the cell structure due to the temperature distribution which occurs inside the cell structure or the pressure applied from outside of the cell structure.

13. A cell structure of which a stress distribution has been analyzed by using the method for analysis of a cell structure as defined in claim 3,
the cell structure having a material fracture stress value greater than a maximum value of the stress which occurs inside the cell structure due to the temperature distribution which occurs inside the cell structure or the pressure applied from outside of the cell structure.

14. A cell structure of which a stress distribution has been analyzed by using the method for analysis of a cell structure as defined in claim 6,
the cell structure having a material fracture stress value greater than a maximum value of the stress which occurs inside the cell structure due to the temperature distribution which occurs inside the cell structure or the pressure applied from outside of the cell structure.
